(19) United States
(12) Patent Application Publication
(10) Pub. No.: US 2016/0255817 A1
(43) Pub. Date: Sep. 8, 2016

(54) COLLAR APPARATUS WITH A PHOTOLUMINESCENT COMPONENT

(71) Applicant: Doskocil Manufacturing Company, Inc., Arlington, TX (US)

(72) Inventor: Jack RENFORTH, Azle, TX (US)

(21) Appl. No.: 15/058,778

(22) Filed: Mar. 2, 2016

Related U.S. Application Data
(60) Provisional application No. 62/127,386, filed on Mar. 3, 2015.
(60) Provisional application No. 62/296,365, filed on Feb. 17, 2016.

(51) Int. Cl. A01K 27/00

(52) U.S. Cl. CPC A01K 27/006; A01K 27/001

(57) ABSTRACT

A collar apparatus includes a flexible collar body configured to be removably disposed about around a neck of an animal when first and second ends are adjacent each other, and including a photoluminescent component, and a closure situated on the collar body and operable to move the collar body between a closed condition wherein the collar body and the closure form a closed loop and an open state wherein the collar body and the closure do not form a closed loop.

### CROSS-REFERENCE TO RELATED APPLICATIONS

This application claims priority to U.S. Provisional Application No. 62/127,386, filed Mar. 3, 2015 and U.S. Provisional Application No. 62/296,365, filed Feb. 17, 2016, the contents of which is hereby incorporation herein by reference.

### BACKGROUND

1. Field of Invention

The invention relates generally to animal collars. More particularly, one embodiment is directed to animal collars having glow in the dark features.

2. Background of the Invention

Animals such as dogs, cats, and the like can spend time outdoors, either being walked (such as in the way dogs are regularly walked) or in an uncontrolled fashion (such as in the way dogs and cats are let outside to relieve themselves and to indulge basic animal instincts such as hunting, etc.). Since such animals can be outside during the nighttime, it would be desirable to avoid having animals that may run across the road from being hit by cars or other vehicles. While animals could be caused to carry electrically illuminated devices such as LEDs, incandescent lamps, and the like, the need for a power source such as a battery renders such somewhat inconvenient to use. It thus would be desirable to enhance the visibility of animals at nighttime in a fashion that is convenient to the pet owner.

### SUMMARY

Accordingly, an improved animal collar apparatus advantageously is formed of a material that includes a photoluminescent component, thereby making the collar apparatus itself photoluminescent or “glow in the dark”. In one embodiment, the polymeric material is PVC that has a photoluminescent component mixed therewith prior to curing. The collar apparatus thus is photoluminescent, meaning that it emits visible light after absorption of certain electromagnetic radiation.

In one embodiment, a collar apparatus includes a flexible collar body configured to be removably disposed about around a neck of an animal when first and second ends are adjacent each other, and including a photoluminescent component, and a closure situated on the collar body and operable to move the collar body between a closed condition wherein the collar body and the closure form a closed loop and an open state wherein the collar body and the closure do not form a closed loop.

### BRIEF DESCRIPTION OF THE DRAWINGS

Referring now to the attached drawings which form a part of this original disclosure.

FIG. 1 is a plan view of a collar according to an embodiment;

FIG. 2 is a top plan view the collar of FIG. 1 in a connected state; and

FIG. 3 is a top perspective of the process of adding polymeric material into a mold to form the collar body of the collar of FIG. 1.

### DETAILED DESCRIPTION OF THE EMBODIMENTS

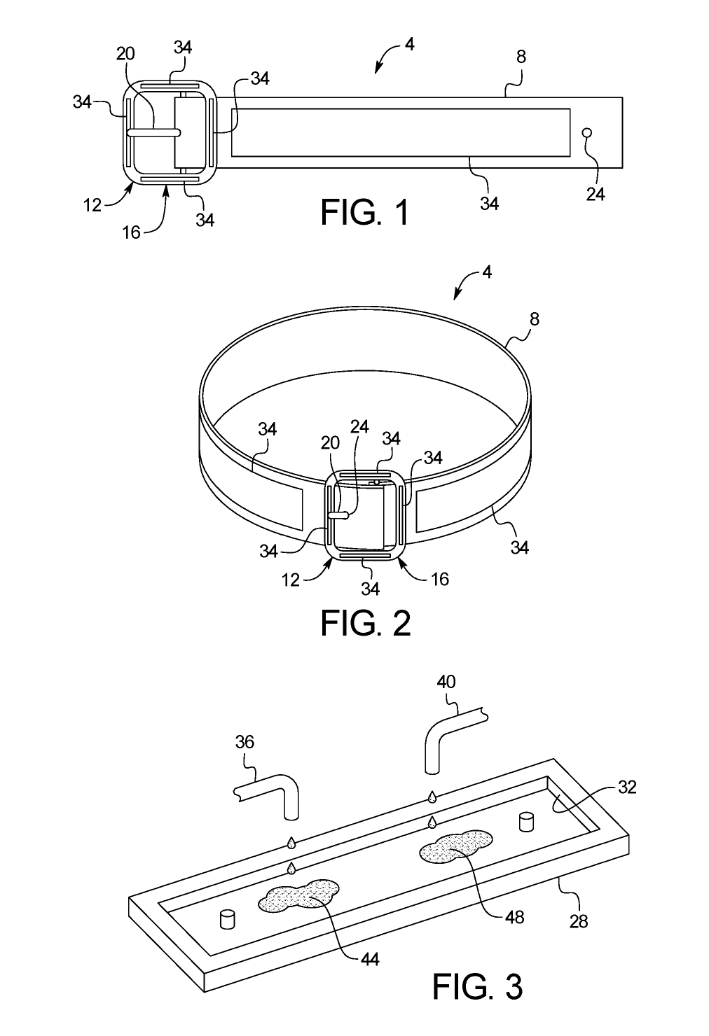

An improved collar apparatus 4 in accordance with the disclosed and claimed concept is depicted generally in FIGS. 1 and 2. The collar apparatus 4 can to include a collar body 8 and a closure 12 that are connected together in any of a variety of fashions. The collar body 8 is an elongated and flexible belt-like body that is formed of a polymeric material that is photoluminescent. The closure 12 in the depicted exemplary embodiment is a buckle-type closure that includes a buckle 16 having a tang 20 that is mounted to an end of the collar body 8. The collar body 8 includes a hole 24 formed therein near an end opposite the buckle 16 that is configured to receive the tang 20 therein to place the collar apparatus 4 in a closed condition such as is depicted generally in FIG. 2. The collar apparatus 4 in the closed condition of FIG. 2 is arranged to have a generally closed loop that receives an animal's neck therein. The tang 20 is removable from the hole 24 to return the collar apparatus 4 to an open condition wherein the collar body 8 does not form a part of a closed loop. However, it is noted that the closure 12 can be any suitable closure.

In one embodiment, as shown in FIG. 3, the collar body 8 is formed by placing uncured polymeric materials into a mold 28 and by then performing an appropriate curing operation on the polymeric materials to cause the materials to reach a cured state. The collar body 8 can then be removed from the mold 28 and can have the closure 12 attached thereto.

The mold 28 is depicted in FIG. 3 as having a cavity 32 that receives uncured polymeric material 44 from a first tap 36 and that receives other uncured polymeric material 48 from a second tap 40. In the depicted exemplary embodiment, the uncured polymeric material 44 includes a photoluminescent component whereas the uncured polymeric material 48 does not include a photoluminescent component. The result of using two different polymeric materials, one being photoluminescent and the other not being photoluminescent, will result in the collar body 8 having some type of pattern of photoluminescence and non-photoluminescence that may be selected based on various aesthetic and/or functional purposes. For example, the two uncured polymeric materials 44 and 48 can be placed in a camouflage-like arrangement to provide a glow-in-the-dark functionality that appears camouflage-like. Alternatively, the uncured material 44 having the photoluminescent component may be applied in a chevron-like pattern in combination with the uncured polymeric material 48 to result in glow-in-the-dark chevron being formed in the collar body. It is understood that the uncured polymeric materials 44 and 48 can be applied in virtually any fashion to the cavity 32 to result in desirable designs, and it is further noted that the first and second taps 36 and 40 are merely exemplary in both nature and quantity and potentially can be robotically controlled to generate repeatable designs. It is further noted that the use of multiple uncured polymeric materials is unnecessary, and rather is expressly noted that the entirety of the collar body 8 can be formed of the same polymeric material having a luminescent component.

In use, the collar apparatus 4 and, more particularly, the collar body 8, is subjected to electromagnetic radiation such as is visible light. Such visible light will cause photoexcitation of the photoluminescent component of the polymeric material that is used to form the collar body 8. Such photoexcitation causes the photoluminescent component and thus the collar body 8 itself to emit visible light via photoluminescence. In so doing, it may be necessary to remove the collar apparatus 4 from the animal in order to fully expose the collar body 8 to the electromagnetic radiation, although this need not be the case depending upon the excitation light that is available. The photoexcitation of the photoluminescent collar body 8 can be refreshed or recharged with the use of street lights, house lights, flashlights, and the like without limitation. The improved collar apparatus 4 thus emits visible light via photoluminescence and increases the visibility of the animal to drivers and others, all of which is highly desirable.

In one embodiment, photoluminescent component 34 can be thermoplastic rubber (TPR), in which a portion of the collar apparatus 4 is made. For example, portions of the collar body 8 and/or the closure 12 can be formed from the photoluminescent component. Accordingly, in one embodiment, the closure 12 or portions of the closure 12 are molded using a photoluminescent component 34. That is, thermoplastic material (or other suitable material) is formed or infused with a photoluminescent component prior to the molding or form process. In another embodiment, the photoluminescent component 34 is added to the collar body 8 and/or the closure 12 after the molding process or forming process. It is noted that any suitable photoluminescent component 34 can be disposed on the collar body 8 and/or the closure 12, including but not limited to glow in the dark tape, glow in the dark paint and any other suitable glow in the dark material. Moreover, the photoluminescent component 34 can be disposed on a suitable portion of the collar body 8 and/or the closure 12, and can include the entire collar body 8 and the closure 12.

Additionally, the photoluminescent component 34 can be in various decorative configurations. For example, the photoluminescent component 34 can be in a web shaped configuration, a plurality of circles or other shapes or in any suitable configuration. The photoluminescent component 34 can be the actual design (e.g., circles) or is can be inverse of the design (e.g., the background on which the circles are disposed). Further, the photoluminescent component 34 can be solid or in any suitable design.

Accordingly, the collar described herein increases safety at night due to increased visibility. For example, when an animal is on a leash or simply out at night without a leash, the photoluminescent component will enable higher visibility of the animal to increase the safety of the animal and/or a person walking the animal.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A collar apparatus comprising:
a flexible collar body configured to be removably disposed about around a neck of an animal when first and second ends are adjacent each other, and including a photoluminescent component; and
a closure disposed on the collar body and operable to move the collar body between a closed condition wherein the collar body and the closure form a closed loop and an open state wherein the collar body and the closure do not form a closed loop.

2. The collar apparatus according to claim 1, wherein
the photoluminescent material is disposed on an exterior portion of the flexible collar body.

3. The collar apparatus according to claim 1, wherein
the photoluminescent material is one of glow in the dark tape and glow in the dark paint.

4. The collar apparatus according to claim 1, wherein
the flexible collar body is formed at least in part of a polymeric material including the photoluminescent component.

5. The collar apparatus according to claim 1, wherein
the photoluminescent component is disposed on a portion of the flexible collar body.

6. The collar apparatus according to claim 1, wherein
the photoluminescent component is disposed on a portion of the closure.

7. The collar apparatus according to claim 1, wherein
the photoluminescent component is a thermoplastic rubber.

8. A method of forming a glow in the dark collar apparatus, comprising:
receiving in an elongated cavity of a mold a polymeric material having a photoluminescent component; and
curing the polymeric material in situ in the cavity to form an elongate flexible belt-like collar body that includes the photoluminescent component.

9. The method according to claim 8, wherein
the photoluminescent material is disposed on a portion of a closure of the collar apparatus.

10. The method according to claim 8, wherein
the polymeric material is a first polymeric material, and receiving in the elongated cavity of the mold a second polymeric, the second polymeric without the photoluminescent component.

11. The method according to claim 10, further comprising
dispensing the first polymeric material into the elongated cavity of the mold using a first tap.

12. The method according to claim 11, further comprising
dispensing the second polymeric material into the elongated cavity of the mold using a second tap.
